(19) United States
(12) Patent Application Publication
(10) Pub. No.: US 2014/0305812 A1
(43) Pub. Date: Oct. 16, 2014

(54) METHOD FOR ANALYZING A GAS

(71) Applicant: Robert Bosch GmbH, Stuttgart (DE)

(72) Inventors: Richard Fix, Gerlingen (DE); Denis Kunz, Untergruppenbach (DE); Andreas Krauss, Tuebingen (DE); Kathy Sahner, Leonberg (DE); Philipp Nolte, Gerlingen (DE)

(73) Assignee: Robert Bosch GmbH, Stuttgart (DE)

(21) Appl. No.: 14/252,976

(22) Filed: Apr. 15, 2014

(30) Foreign Application Priority Data
Apr. 15, 2013 (DE) 10 2013 206 637.6

(51) Int. Cl. G01N 27/333

(52) U.S. Cl. CPC G01N 27/333
USPC 205/789

(57) ABSTRACT

A method for analyzing a gas includes measuring a concentration of a chemical species of the gas in a measuring space of a gas sensor. The gas sensor has a semiconductor substrate with an electrical circuit and a first thin-film ion conductor that separates a reference space for a reference gas from the measuring space for the gas. The first thin-film ion conductor has a reference electrode that faces the reference space and a measuring electrode that faces the measuring space. The reference electrode and the measuring electrode are connected to the electrical circuit. The measuring of the chemical species includes picking off an electrical voltage between the reference electrode and the measuring electrode of the gas sensor. A partial pressure of the chemical species in the gas is determined by processing the electrical voltage in the electrical circuit by using a stored processing specification.

This application claims priority under 35 U.S.C. §119 to patent application no. DE 10 2013 206 637.6 filed on Apr. 15, 2013 in Germany, the disclosure of which is incorporated herein by reference in its entirety.

### BACKGROUND

The present disclosure relates to a method for analyzing a gas and to a corresponding computer program product.

In order to be able to adapt a ratio between an amount of fuel for a combustion process and an amount of oxygen that is available, information indicating an oxygen concentration in an exhaust gas of the combustion process is required.

DE 199 41 051 A1 describes a sensor element for determining the oxygen concentration in gas mixtures and a method for producing the same.

### SUMMARY

Against this background, the present disclosure presents a method for analyzing a gas and a corresponding computer program product. Advantageous refinements are provided by the respective subclaims and the description that follows.

For analyzing a gas, a gas sensor may be used. The gas sensor may be used for at least sensing a concentration of one chemical species as a constituent of the gas. The gas sensor may reproduce the concentration in the form of an electrical signal.

A sensor element of the gas sensor may be produced using microsystems technology or semiconductor technology. This allows layers with small thicknesses, down to a few atomic layers, to be deposited by a reliable process. An electrical circuit that can process electrical signals of the sensor element and can present them as standardized data on a data line may be integrated in a semiconductor substrate of the gas sensor or on a dedicated chip of the gas sensor. A spatial proximity of the electrical circuit to the sensor element also allows the registration of very weak changes of the electrical signals, which would possibly be lost in the noise or on account of electromagnetic interferences in the case of signal processing in a separate control device. A high degree of production precision on account of the semiconductor technology or microsystems technology allows a large number of gas sensors to be produced with little production variation. The standardized data can be provided in the electrical circuit with little effort.

A method for analyzing a gas is presented, the method having the following steps:

providing a gas sensor, the gas sensor having a carrier material for a first thin-film ion conductor and an electrical circuit, the first thin-film ion conductor separating a reference space for a reference gas from a measuring space for the gas, the first thin-film ion conductor having a reference electrode and a measuring electrode, the reference electrode facing the reference space and the measuring electrode facing the measuring space, the reference electrode and the measuring electrode being connected to the electrical circuit;

measuring an electrical voltage between the reference electrode and the measuring electrode, in order to measure the concentration; and

determining a partial pressure of the chemical species in the gas, the electrical voltage being processed in the electrical circuit by using a stored processing specification, in order to determine the partial pressure.

A gas sensor may be understood as meaning a microelectrochemical gas sensor, which is produced by using processes of microsystems technology with minimal device-to-device variation. The carrier material may be a wafer or a chip. The carrier material may be a semiconductor. The carrier material may be a precisely structurable material, such as for example a Foturan glass. If the carrier material is a semiconductor substrate, the electrical circuit may be integrated in the semiconductor substrate. Then, the electrical circuit may be implemented using semiconductor properties of the semiconductor substrate. A thin-film ion conductor may be a fluid-impermeable membrane that closes an opening in the carrier material, in order to separate a first volume from a second volume. The first volume and the second volume may be chambers or channels that are separate from one another. The first volume may be referred to as a reference space. The reference space may be designed for carrying a gas with a known composition, a reference gas. The reference space may for example contain air. Then, the reference space may be fluidically connected to the surroundings. Similarly, the reference space may contain another gas with a known composition. For example, the reference space may carry pure oxygen. The second volume may be referred to as the measuring space. The measuring space may be designed for carrying a gas with an unknown composition or a gas to be measured. The measuring space may for example carry a combustion exhaust gas. The thin-film ion conductor may be coated in an electrically conducting manner on both sides with electrodes. The electrodes may be gas-permeable. The electrodes may have catalytic properties. For example, the electrodes may contain a catalytically active metal or consist thereof. The electrodes may be designed for ionizing at least one chemical species. The thin-film ion conductor may comprise a ceramic material. The thin-film ion conductor may be permeable to ions of the chemical species. The thin-film ion conductor may be electrically insulating or have a very low electrical conductivity. An electrical resistance of the thin-film ion conductor may be frequency-dependent. The electrodes may conduct charge carriers that are split off during the ionization. Between the electrodes there may be an electrical voltage, which is dependent on a difference in concentration of at least one of the chemical species in the two volumes. A partial pressure may represent an amount of the chemical species per volume unit. The processing specification may reproduce a correlation between the voltage and the partial pressure.

The partial pressure may be determined by using a compensation characteristic stored in the electrical circuit to compensate for production tolerances of the gas sensor. For example, the gas sensor may be calibrated under controlled conditions. A deviation of the electrical voltage, determined during the calibration, from an expected electrical voltage when there is a known difference in concentration may be stored in a compensation characteristic. A characteristic may reproduce a relationship between the electrical voltage and the difference in concentration. The characteristic may have a characteristic profile. For example, the characteristic may have a great slope in the range of λ=1. The compensation characteristic may be stored in a database. Intermediate values may be interpolated. The compensation characteristic allows the gas sensor to provide a standardized signal directly. As a result, there is no need for a signal processing previously stored after the event in a control device. An exchange of a sensor can be performed without having to make changes to the control device.

The voltage may be amplified by a factor stored in the electrical circuit or a mathematical function, in order to determine the partial pressure. In a first range of λ<1 and/or in a second range of λ>1, the voltage may have a small or diminishing change. Amplifying the voltage can have the effect of increasing a measurability of the voltage. Similarly, a resolvability for individual λ values can be improved. A small distance between the thin-film ion conductor and the electrical circuit allows the voltage to be amplified with little noise from the electrical circuit.

The gas sensor may be provided with a second thin-film ion conductor. The measuring space may be formed as a hollow space arranged in the carrier material. The second thin-film ion conductor may separate the measuring space from a gas space for the gas. The measuring space may be connected to the gas space by a diffusion barrier. The diffusion barrier may make possible a controlled diffusion of the gas between the measuring space and the gas space. The second thin-film ion conductor may have a first pumping electrode and a second pumping electrode. The first pumping electrode may be arranged facing the measuring space. The second pumping electrode may be arranged facing the gas space. The first pumping electrode and the second pumping electrode may be connected to the electrical circuit. The method for analyzing a gas may have a pumping step and a sensing step. In the pumping step, ions of the chemical species may be pumped through the second thin-film ion conductor until there is in the measuring space a concentration of the chemical species that is stored in the electrical circuit. In this case, an electrical pumping voltage may be applied between the first pumping electrode and the second pumping electrode, in order to pump the ions through the second thin-film ion conductor. In the sensing step, an ion current through the second thin-film ion conductor can be sensed, an electrical current flow between the first pumping electrode and the second pumping electrode being measured, in order to sense the ion current. The partial pressure can also be determined by using the pumping voltage and the current flow. Like the first thin-film ion conductor, the second thin-film ion conductor may close an opening in the carrier material. A diffusion barrier may for example consist of a porous material. The diffusion barrier allows a maximum of a predetermined gas stream to pass from the gas space into the measuring space, or vice versa. In the pumping step, the functioning mode of the thin-film ion conductor from the measuring step may be reversed, in that ions are transported through the second thin-film ion conductor while expending energy. The pumping may take place in both directions, in order to subtract or add at least one chemical species from the hollow space. Since the ions are charge carriers, during the pumping electrical charge carriers are moved as an ion current from the first pumping electrode to the second pumping electrode, or vice versa. The movement of the charge carriers results in the electrical current flow between the pumping electrodes. The electrical current flow may be proportional to the ion current through the second thin-film ion conductor.

The pumping voltage may be controlled by using the voltage at the first thin-film ion conductor. For example, the pumping voltage may be controlled to a value of λ=1 in the measuring space. It may also be controlled to a value of λ<1 or λ>1. For the controlling, the electrical circuit may have a proportional and/or integral and/or differential controller part.

When the chemical species is pumped out from the hollow space, pumping may be continued until only extremely small amounts of atoms and/or molecules of the chemical species remain in the hollow space. The pumping voltage at the second thin-film ion conductor may be reduced if the partial pressure of the substance in the hollow space is less than a control value. If the concentration of the species in the hollow space is less than a setpoint value, the pumping voltage may be reversed, in order to pump the species into the chamber. In the case of oxygen, it may be oxygen directly, or oxygen-containing molecules (for example water), which are decomposed into oxygen before incorporation in the electrolyte at the electrode.

If it is known on account of the application that λ is always >=1, there is no need for control and, for example, the species can be pumped with a constant voltage. The voltage is sufficient if, in spite of minor variation of the voltage, there is no longer any change of current. In this case it is also possible to dispense with the first thin-film electrolyte with the measuring/reference electrode and the reference space.

The method may have a step of determining a temperature of the first thin-film ion conductor and/or the second thin-film ion conductor. The partial pressure may also be determined by using the temperature. The temperature of the thin-film ion conductor may be sensed by using a suitable temperature sensor at or on the membrane. For example, a PTC thermistor or a thermocouple may be arranged at the thin-film ion conductor, in the region of the thin-film ion conductor or in the thin-film ion conductor. Similarly, the temperature may be sensed by way of a frequency-dependent electrical resistance of the thin-film ion conductor. For this purpose, the electrodes of one of the thin-film ion conductors may be subjected to an alternating voltage signal by the electrical circuit. The alternating voltage signal may be provided at different frequencies, in order to eliminate capacitive effects between the electrodes. The alternating voltage signal may also be a series of voltage pulses. Depending on the temperature of the thin-film ion conductor, the ionization of the chemical species can proceed at different rates. The conductivity of the thin-film ion conductor may be temperature-dependent on account of ion conduction mechanisms.

The method may have a step of controlling the temperature of the first thin-film ion conductor and/or the second thin-film ion conductor. In this case, the temperature of the first thin-film ion conductor is controlled to a first temperature, in order to measure the concentration. Alternatively or in addition, the temperature of the second thin-film ion conductor is controlled to a second temperature, in order to pump the ions. For controlling the temperature, the first thin-film ion conductor may have a first heater. The second thin-film ion conductor may have a second heater. Alternatively, a common heater may control the temperature of both thin-film ion conductors. A heater may be an electrical conductor with a defined electrical resistance, which converts electrical energy into thermal energy when there is a current flow. The electrical conductor may be arranged at the thin-film ion conductor, in the region of the thin-film ion conductor or in the thin-film ion conductor. The heater may be supplied by the electrical circuit. The heater may also be used for measuring the temperature by a resistance measurement in the heater. A heater allows the gas to be analyzed independently of a temperature of the gas.

The temperature of the first thin-film ion conductor may be controlled to a further temperature, in order to measure a further concentration of a further chemical species. Alternatively or additionally, the temperature of the second thin-film ion conductor may be controlled to another temperature, in order to pump the further chemical species. In the determining step, a further partial pressure of the further chemical species may be determined Changing the temperature of the first thin-film ion conductor and/or the second thin-film ion conductor allows a changed operating range to be set. With a changed temperature, the thin-film ion conductor and/or its electrodes may have changed chemical properties. For example, at a higher temperature, molecules with a higher bonding energy between the atoms can be ionized. Further examples of temperature-dependent mechanisms on the electrode surface are adsorption, dissociation, desorption, reaction with other species and diffusion properties. The first temperature and the further temperature may be changed at a predetermined time interval. The second temperature and the other temperature may be changed in a predetermined rhythm. On account of the small layer thickness of the thin-film ion conductors and the carrier material, the different temperatures can be set with little delay. This allows quick changing between temperatures. With a periodic change between the temperatures, different gas constituents can be analyzed one after the other with the gas sensor. There may even be a non-periodic change between the temperatures.

Also of advantage is a computer program product with program code, which can be stored on a machine-readable carrier such as a semiconductor memory, a hard-disk memory or an optical memory and is used for carrying out the method as provided by one of the embodiments described above when the program product is run on a computer or device.

### BRIEF DESCRIPTION OF THE DRAWINGS

The disclosure is explained in more detail below by way of example on the basis of the accompanying drawings, in which:

FIG. 1 shows a block diagram of a gas sensor for analyzing a gas according to an exemplary embodiment of the present disclosure;

FIG. 2 shows a flow diagram of a method for analyzing a gas according to an exemplary embodiment of the present disclosure;

FIG. 3 shows a representation of a characteristic of a gas sensor;

FIG. 4 shows a representation of a characteristic of a gas sensor with an operating range according to an exemplary embodiment of the present disclosure;

FIG. 5 shows a representation of a characteristic of a gas sensor with an extended operating range according to an exemplary embodiment of the present disclosure;

FIG. 6 shows a representation of a detail of a number of characteristics of gas sensors;

FIG. 7 shows a representation of a detail of a number of characteristics of gas sensors with a compensation according to an exemplary embodiment of the present disclosure;

FIG. 8 shows a representation of a detail of a flat characteristic of a gas sensor;

FIG. 9 shows a representation of a detail of a characteristic of a gas sensor after an amplification according to an exemplary embodiment of the present disclosure;

FIG. 10 shows a representation of a characteristic of a wideband sensor;

FIG. 11 shows a representation of a detail of a number of characteristics of wideband sensors;

FIG. 12 shows a representation of a detail of a number of characteristics of wideband sensors with a compensation according to an exemplary embodiment of the present disclosure;

FIG. 13 shows a representation of a temperature profile of a gas sensor when heating up the thin-film ion conductor according to an exemplary embodiment of the present disclosure; and

FIG. 14 shows a representation of a temperature profile of a gas sensor when cooling down the thin-film ion conductor according to an exemplary embodiment of the present disclosure.

### DETAILED DESCRIPTION

In the description that follows of preferred exemplary embodiments of the present disclosure, the same or similar reference signs are used for the elements that are represented in the various figures and act in a similar way, without the description of these elements being repeated.

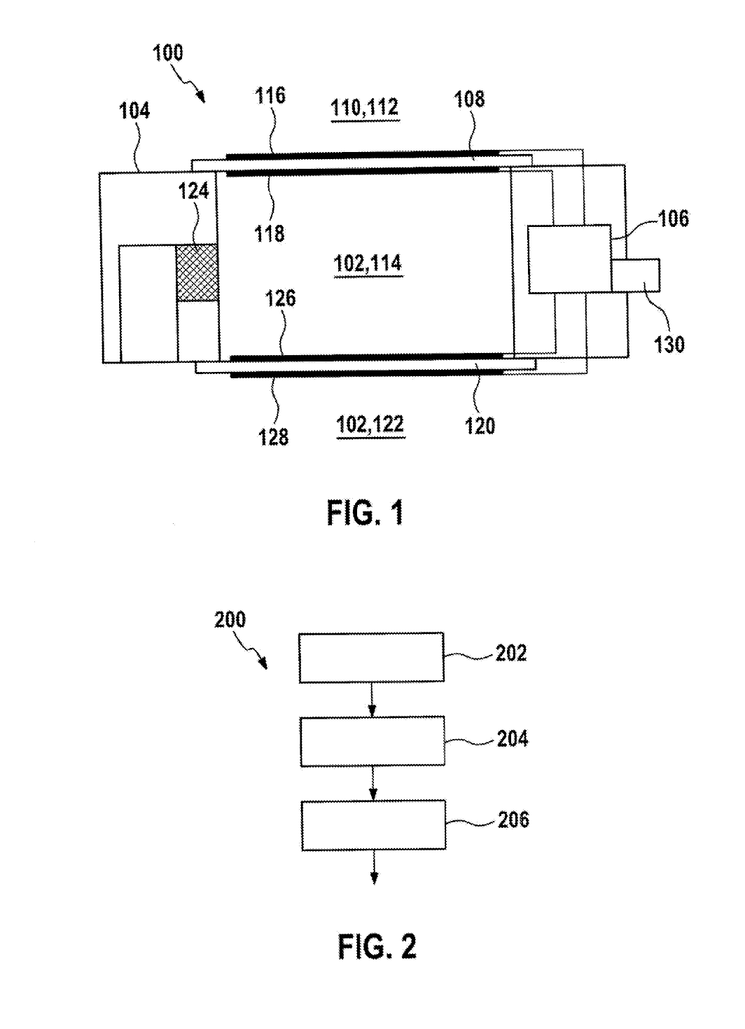

FIG. 1 shows a block diagram of a gas sensor 100 for analyzing a gas 102 according to an exemplary embodiment of the present disclosure. The gas sensor has a carrier material 104 for a first thin-film ion conductor 108 and an electrical circuit 106. The first thin-film ion conductor 108 separates a reference space 110 for a reference gas 112 from a measuring space 114 for the gas 102. The first thin-film ion conductor 108 has a reference electrode 116 and a measuring electrode 118. The reference electrode 116 is facing the reference space 110. The measuring electrode 118 is facing the measuring space 114. The reference electrode 116 and the measuring electrode 118 are connected to the electrical circuit 106. In the exemplary embodiment represented here, the gas sensor 100 additionally has a second thin-film ion conductor 120. The gas sensor 100 may also be provided without the second thin-film ion conductor 120. Here, the measuring space 114 is formed as a hollow space 114 arranged in the carrier material 104. The hollow space 114 may be directly connected to the substrate material 104. However, the hollow space 114 may also be separated from the substrate material 104 by layers/layer systems of other materials. The second thin-film ion conductor 120 separates the measuring space 114 from a gas space 122 for the gas 102. The measuring space 114 is connected to the gas space 122 by a diffusion barrier 124. The diffusion barrier 124 makes possible a controlled diffusion of the gas 102 between the measuring space 114 and the gas space 122. The second thin-film ion conductor 120 has a first pumping electrode 126 and a second pumping electrode 128. The first pumping electrode 126 is facing the measuring space 114. The second pumping electrode 128 is facing the gas space 122. The first pumping electrode 126 and the second pumping electrode 128 are connected to the electrical circuit 106. The electrical circuit 106 has an interface 130 for communicating via a data line.

In other words, FIG. 1 shows a basic structure of a sensor 100 on the basis of thin-film ion conductors 108, 120. The thin-film ion conductors 108, 120 may be operated as a two-state sensor, in which a voltage signal between the measuring electrode 118 and the reference electrode 116 is measured. The reference electrode 116 may also be operated as a pumped reference, whereby an oxygen reservoir can be formed on the reference side Similarly, the thin-film ion conductors 108, 120 may be operated as a wideband sensor, in which a pumping current through an electrochemical pumping cell is measured, the current corresponding to the inward-diffusing limit flow of gas molecules through an upstream diffusion barrier 124. The approach presented here describes gas sensors 100 for the characterization of the residual oxygen fraction in combustion gases, in particular with the function as a two-state lambda sensor and as a wideband lambda sensor as well as a sensor 100 for hydrocarbons and NH₃ in the exhaust gas of internal combustion engines.

FIG. 2 shows a flow diagram of a method 200 for analyzing a gas according to an exemplary embodiment of the present disclosure. The method 200 may be performed by using the gas sensor from FIG. 1. The method 200 has a providing step 202, a measuring step 204 and a determining step 206. In the providing step 202, a gas sensor is provided. Unlike in FIG. 1, the gas sensor has a semiconductor substrate with an electrical circuit and a first thin-film ion conductor. The first thin-film ion conductor separates a reference space for a reference gas from a measuring space for the gas. The first thin-film ion conductor has a reference electrode and a measuring electrode. The reference electrode is facing the reference space. The measuring electrode is facing the measuring space. The reference electrode and the measuring electrode are connected to the electrical circuit. In the measuring step 204, a concentration of a chemical species of the gas in the measuring space is measured. This involves picking off an electrical voltage between the reference electrode and the measuring electrode, in order to measure the concentration. In the determining step 206, a partial pressure of the chemical species in the gas is determined This involves processing the electrical voltage in the electrical circuit by using a stored processing specification, in order to determine the partial pressure.

In other words, FIG. 2 shows an operating strategy for gas sensors on the basis of thin-film ion conductors. So far, ceramic thick-film technology has served as the technological basis for the lambda sensors. Using thin-film ion conductors allows gas sensors to be miniaturized. The approach presented here describes operating modes for gas sensors on the basis of thin-film ion conductors. This involves utilizing the special properties of such a sensor. The gas sensor can be produced by precise methods of microsystems technology. Microelectronics may be integrated on the chip or in a neighboring chip. On account of the small overall size, the gas sensor has a low thermal capacity.

In the case of sensors based on thin-film ion conductors, the operating modes and signal evaluations known from previous lambda sensors can be performed. In addition, an evaluation range of the two-state characteristic of a two-state sensor can be extended. On account of a low production variation and use of integrated microelectronics for calibrating the characteristic, a compensation for the device-to-device variation can be implemented in a gas characteristic. Furthermore, a temperature influence on the sensor characteristic can be compensated by use of the integrated microelectronics. Furthermore, for the operation of a combined mixed-potential sensor, a temperature modulation may be carried out in a combined sensor for measuring further substances, in particular hydrocarbons and ammonia.

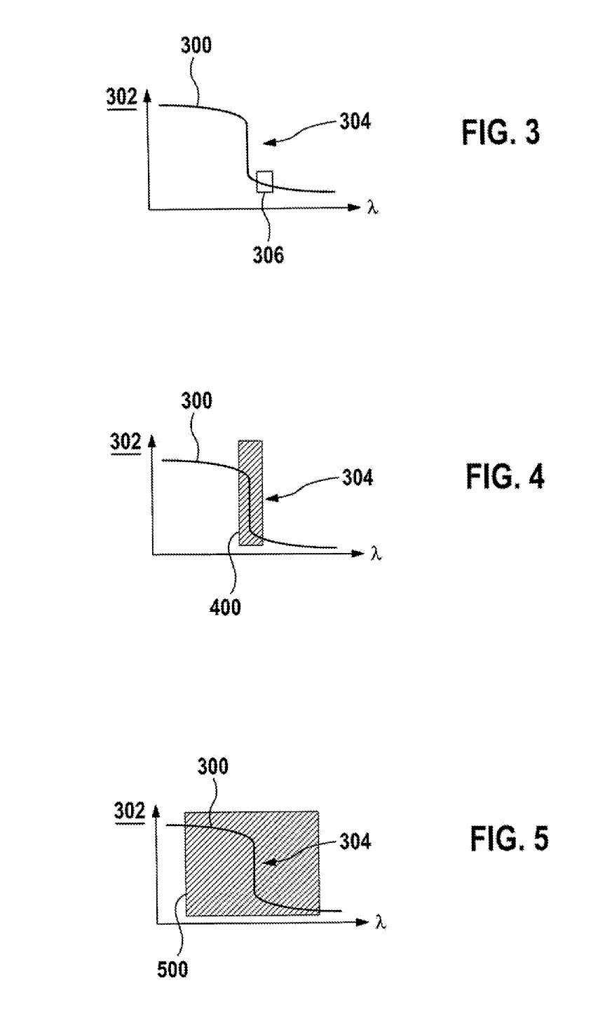

FIG. 3 shows a representation of a characteristic 300 of a gas sensor. The gas sensor may be a gas sensor such as that shown in FIG. 1. The characteristic 300 characterizes a relationship of an electrical voltage 302 between two electrodes at a thin-film ion conductor of the gas sensor and a combustion air ratio λ (lambda). The voltage 302 is plotted on the y axis, λ is plotted on the x axis. The combustion air ratio λ describes a mass ratio of an air mass to a fuel mass, a value of λ=1 representing a balanced, stoichiometric ratio, that is to say that the entire oxygen contained in the air mass can react to form reaction products in a combustion of the fuel mass. After complete combustion with λ=1, a combustion exhaust gas has an oxygen fraction of zero percent. With λ>1, the exhaust gas still contains residual oxygen, and the mixture is a “lean” mixture; with λ<1, the exhaust gas still contains unburned fuel, and the mixture is a “rich” mixture.

With low λ values, the voltage 302 has a high value. The characteristic 300 extends virtually parallel to the x axis and has a low negative slope. With increasing values of λ, the characteristic 300 becomes steeper. With a fixed λ value, for example λ=1, the characteristic 300 is at its steepest. Here, the characteristic 300 extends virtually parallel to the y axis. As from the fixed λ value, the characteristic 300 becomes flatter, until, with high values of λ, the characteristic 300 extends almost parallel to the x axis again. Consequently, the characteristic 300 has at the fixed λ value a point of discontinuity 304, at which the voltage 302 changes very greatly within a small λ range.

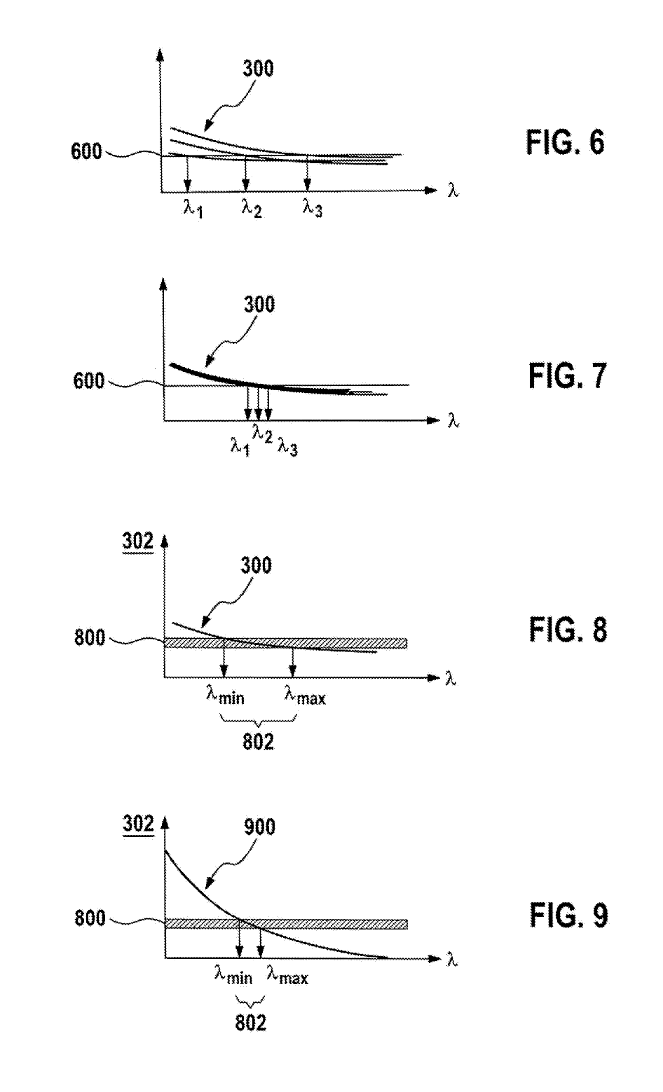

Marked in FIG. 3 is a detail 306 that is represented in FIGS. 6 to 9. The detail is arranged to the right of the point of discontinuity 304 in a transitional region, in which the characteristic flattens off.

FIG. 4 shows a representation of a characteristic 300 of a gas sensor with an operating range 400 according to an exemplary embodiment of the present disclosure. The characteristic 300 corresponds to the characteristic in FIG. 3. Shown as an addition to FIG. 3 is a working range 400, which is arranged in the region of the point of discontinuity 304 and where the characteristic 300 is steep. Within the operating range 400, λ can be resolved very accurately in the electrical voltage 302.

A two-state sensor has a steep characteristic 300 around λ=1, the characteristic 300 representing an assignment between λ and a sensor voltage 302. So far, only the narrow-band steep region 400 around the sudden change in voltage 304 has been used.

FIG. 5 shows a representation of a characteristic 300 of a gas sensor with an extended operating range 500 according to an exemplary embodiment of the present disclosure. The characteristic 300 corresponds to the characteristic in FIG. 3. Shown as an addition to FIG. 3 is an extended operating range 500, which by contrast with the operating range in FIG. 4 extends over a wide range of λ. The extended operating range 500 extends on both sides of the point of discontinuity 304 into the regions of the characteristic 300 in which the slope of the characteristic 300 has very low values.

In the case of gas sensors based on thin-film ion conductors, the measuring range 500 can be extended, so that the flatter region of the characteristic 300 can be used for a λ measurement. This is possible since precise production processes from microsystems technology lead to structures with high precision. A low geometrical device-to-device variation can lead to a reduction in the variation of the characteristics 300. In the ideal case it can lead to congruent sensor characteristics 300 between different individual devices. The microelectrochemical sensor may also have integrated electronics. The microelectronics may be accommodated in the same carrier material or a neighboring chip, in the same way as the thin-film ion conductor. By virtue of the properties of the thin-film sensors, the flat regions are also used for a λ measurement.

FIG. 6 shows a representation of a detail of a number of characteristics 300 of gas sensors. In FIG. 6, the detail from FIG. 3 is shown enlarged. The characteristics 300 have a variation. As a result, an individual voltage value 600 represents a different λ value in the case of each characteristic 300. As a result, the λ values λ1, λ2, λ3 likewise have a variation. The variation of the λ values is particularly pronounced, since the characteristics 300 in the detail represented have a very small slope.

FIG. 7 shows a representation of a detail of a number of characteristics 300 of gas sensors with a compensation according to an exemplary embodiment of the present disclosure. As in FIG. 6, in FIG. 7 the detail from FIG. 3 is shown enlarged. On account of the compensation and/or low production tolerances in the case of the thin-film ion conductors, here the characteristics 300 have a very low variation. In the case of each characteristic 300, the voltage value 600 likewise represents a different λ value. However, the λ values λ1, λ2, λ3 have reduced device-to-device variation. If the variation is sufficiently small, the voltage value 600 can be further processed directly. If, on account of the variation, the accuracy is not sufficient, the variation can be compensated in the electrical circuit of the gas sensor.

A calibrating characteristic of the respective individual sensor device may be stored in the microelectronics and a compensation function may be integrated in the microelectronics. The compensated signal 300 is output by the sensor as a measuring signal. The voltage at the measuring cell or a signal changed after signal transformation may be used as the signal before the compensation.

FIG. 8 shows a representation of a detail of a flat characteristic 300 of a gas sensor. In FIG. 8, the detail from FIG. 3 is shown enlarged. The characteristic 300 represented corresponds to one of the characteristics in FIG. 6. The voltage value from FIG. 6 is represented here as voltage band 800, since the voltage 302 of the electrochemical cell can only be resolved with finite accuracy, for example in voltage steps. The voltage band 800 represents a transmitted signal with limited accuracy. The characteristic 300 has a very small slope within the voltage band 800. Therefore, with a low λ value λ min, the characteristic 300 enters the voltage band 800. With a higher λ value λ max., the characteristic 300 leaves the voltage band 800 again. Between the low λ value λ min and the higher λ value λ max., there is a great λ range 802. The voltage value can therefore only be assigned to the λ range 802. As a result, low slopes of the characteristic 300 produce a systematic inaccuracy.

In the flat part of the characteristic 300, an inaccuracy of the measured voltage 302 is clearly evident as an inaccuracy for λ.

FIG. 9 shows a representation of a detail of a characteristic 900 of a gas sensor after an amplification according to an exemplary embodiment of the present disclosure. As in FIG. 8, the detail from FIG. 3 is shown enlarged. The characteristic 900 is based on the characteristic in FIG. 8. The voltage values 302 have been scaled by a factor. As a result, the characteristic 900 has a steeper slope than in FIG. 8. However, the voltage band 800 has remained equally wide. The steeper characteristic 900 has the effect that the point of entry of the characteristic 900 into the voltage band 800λ min and the point of exit of the characteristic 900 from the voltage band 800λ max. are closer together and the λ range 802 is smaller. The amplification has the effect that the systematic inaccuracy is reduced and λ can be determined more accurately.

The integrated evaluation circuit can perform a transformation of the voltage 302 from the electrodes of the thin-film ion conductor and convert small voltage differences into greater voltage differences. The transformed signal 900 may be used for the characterization of the gas. Smaller differences of the voltage 302 can consequently be distinguished. Individual correction factors may be stored in the microelectronics (on/at the chip). The compensated signal is output by the sensor.

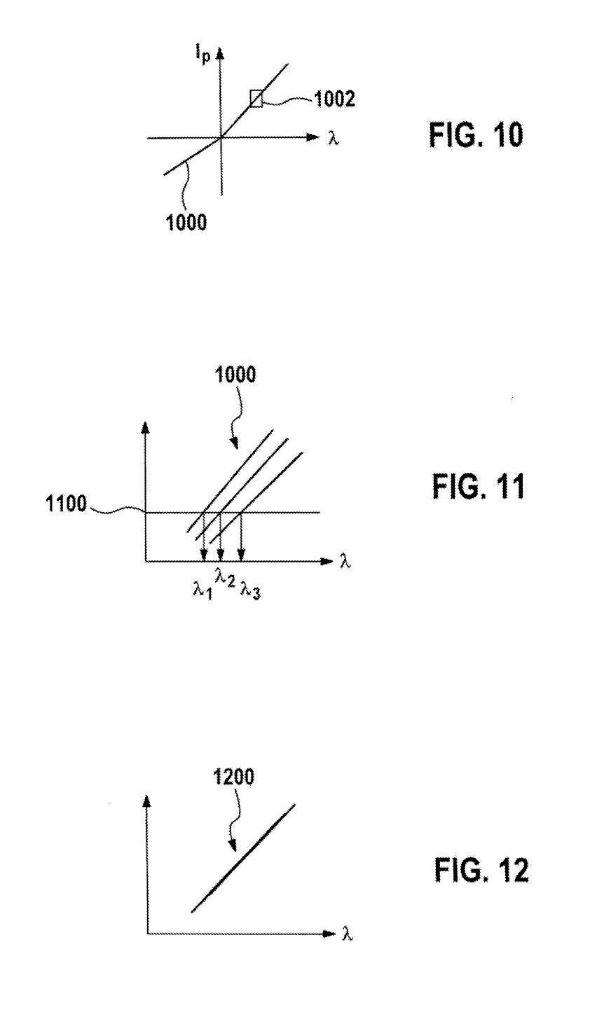

FIG. 10 shows a representation of a characteristic 1000 of a wideband sensor. The wideband sensor corresponds to the gas sensor in FIG. 1 and has a thin-film ion conductor as a pumping membrane. The characteristic 1000 is represented in a Cartesian system of coordinates. The characteristic 100 extends in the first and third quadrants of the system of coordinates. Therefore, the O₂ content or the O₂ deficit is plotted on the x axis in the first quadrant λ. A concentration of another chemical species in the gas at the gas sensor is plotted in the third quadrant. A pumping current I_{P} in the electrochemical cell, which is sensed between the pumping electrodes on the pumping membrane, is plotted on the y axis. In the first quadrant, the characteristic 1000 extends approximately in a straight line from the origin. Consequently, the pumping current I_{P} is approximately proportional to the oxygen content. In the third quadrant, the characteristic 1000 likewise extends approximately in a straight line from the origin. Here, however, the characteristic 1000 has a different slope. Consequently, the characteristic 1000 has a point of inflection at the origin. In FIG. 10, a detail 1002 of the characteristic 1000 is marked in the first quadrant. The detail 1002 is shown enlarged in FIGS. 11 and 12.

In the case of a wideband sensor, device-to-device variations may be reflected in a different slope of the gas characteristic 1000, which represents a current through the electrochemical pumping cell in dependence on the oxygen supply, which restricts the accuracy.

FIG. 11 shows a representation of a detail of a number of characteristics 1000 of wideband sensors. In FIG. 11, the detail from FIG. 10 is shown enlarged. On account of production tolerances, the characteristics 1000 have in each case a slightly different slope. Since the characteristics 1000 are taken from the origin, an individual current value 1100 represents a different λ value in the case of each characteristic 1000. The λ values λ1, λ2, λ3 have a variation.

In order to reduce the variation, a trimming process may be used at the sensor (for example by a trimming resistor at the sensor) or alternatively by compensation by software in the external evaluation electronics.

FIG. 12 shows a representation of a detail of a number of characteristics 1200 of wideband sensors with a compensation according to an exemplary embodiment of the present disclosure. As in FIG. 11, the detail from FIG. 10 is shown enlarged. By virtue of a compensation that is stored in a processing specification and is carried out by the electronic circuit of the gas sensor, the characteristics 1200 all have the same slope, and are consequently congruent. The correction of the pumping current is performed by microelectronics (on/at the chip). Likewise, the semiconductor thin-film technology allows very small tolerances to be maintained in the production of the gas sensors, which can reduce the compensating effort or even make it superfluous, since the thin-film ion conductors of the gas sensors may have virtually identical electrochemical properties.

In the case of a sensor based on thin-film ion conductors, further compensating solutions are possible. It is also the case here that, on account of precise production processes from microsystems technology, structures with high precision can be expected. The low geometrical device-to-device variation will also lead to a reduction in the variation of the characteristics 1200. In the ideal case it will lead to congruent sensor characteristics 1200 between different individual devices. Consequently, no trimming process would be required at the sensor. Then the current through the electrochemical pumping cell can be used directly (i.e. without correction factors) for measuring λ (or an oxygen surplus/deficit). For a further improvement, electronics may be integrated in the microelectrochemical sensor for signal evaluation. This allows a trimming process to be carried out at the sensor. The microelectronics may be accommodated in the same chip as the thin-film ion conductor or a neighboring chip. In this case, a calibrating characteristic of the individual device may be stored in the microelectronics and a compensation function may be integrated in the microelectronics. The compensated signal 1200 is output by the sensor as a measuring signal.

Furthermore, a compensation of the temperature dependence may be performed. Lambda sensors (both as a two-state sensor and as a wideband sensor) show a temperature dependence in their signal. On the chip there may be a device for measuring the temperature. Alternatively or in addition, the internal resistance of the thin-film electrolyte may be used in order to determine the temperature.

The response to temperature changes of the measuring signal of the sensor may be stored as a function in the microelectronics. In this case, the stored function for a two-state sensor is different than for a wideband sensor. If both the signal of the electrochemical cell and the temperature are available, a correction of the signal can be carried out by the microelectronics. The compensated signal is output by the sensor.

This temperature compensation may be of significance in particular if no temperature control is used. Similarly, the temperature compensation may be of significance if a target temperature has not yet been reached when the sensor is switched on. Similarly, if the ambient temperature (of the gas to be measured) is higher than the target temperature. If no heater is used and heating only takes place by the measuring gas/surroundings, the temperature compensation may be important.

With gas sensors on a thin-film basis, different operating temperatures can be set more quickly than in the case of gas sensors on a thick-film basis. Since the new temperature is reached more quickly, measuring under stable conditions can be performed more quickly.

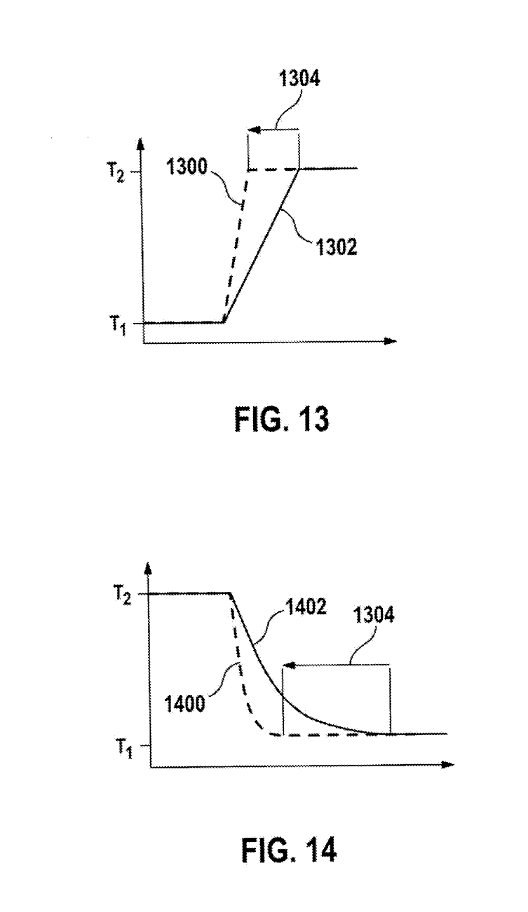

FIG. 13 shows a representation of a temperature profile 1300 of a gas sensor when heating up the thin-film ion conductor according to an exemplary embodiment of the present disclosure. The temperature profile 1300 is shown in a diagram. The time is plotted on the x axis. A temperature is plotted on the y axis. The thin-film ion conductor is heated up by a heater to change the temperature. The temperature profile 1300 starts at a low temperature T1 and remains constantly at the temperature T1. Then the temperature increases linearly, until a higher temperature T2 is reached. The temperature subsequently remains at the high level T2. The temperature profile 1300 represents a heating-up phase at a gas sensor produced by thin-film technology, with a very low thermal capacity of the thin-film ion conductor. Therefore, the slope of the temperature profile 1300 between the low temperature T1 and the high temperature T2 is great. It takes little time to reach the temperature T2. In the diagram, a further temperature profile 1302 is represented. The further temperature profile 1302 represents a further gas sensor with a higher thermal capacity than the gas sensor with the temperature profile 1300. In the case of the further temperature profile 1302, the temperature likewise increases linearly from the value T1 to the value T2. In this case, however, the increase is slower, that is to say flatter, than in the case of the temperature profile 1300. Since the temperature profile 1300 reaches the temperature T2 more quickly, a time gain 1304 is obtained in comparison with the further temperature profile 1302.

FIG. 14 shows a representation of a temperature profile 1400 of a gas sensor during the cooling down of the thin-film ion conductor according to an exemplary embodiment of the present disclosure. As in FIG. 13, the temperature profile 1400 is shown in a diagram with the time on the x axis and the temperature on the y axis. The temperature profile 1400 starts at a high temperature T2 and remains constantly at the temperature T2. For the change in temperature, either the heater is deactivated or it is operated at reduced power. Then the temperature drops exponentially, until a lower temperature T1 is reached. The temperature subsequently remains at the low level T1. The temperature profile 1400 represents a cooling-down phase at a gas sensor produced by thin-film technology with a very low thermal capacity of the thin-film ion conductor.

It therefore takes little time to reach the temperature T1. The temperature profile quickly approaches the low temperature T1.

A further temperature profile 1402 is shown in the diagram. The further temperature profile 1402 represents a further gas sensor with a higher thermal capacity than the gas sensor with the temperature profile 1400. In the case of the further temperature profile 1402, the temperature likewise drops exponentially from the value T2 to the value T1. However, in this case the drop takes place more slowly, that is to say is flatter than in the case of the temperature profile 1400. Since the temperature profile 1400 reaches the temperature T1 more quickly, a time gain 1304 is obtained in comparison with the further temperature profile 1302.

In other words, FIGS. 13 and 14 show a temperature modulation for the operation of a combined mixed-potential sensor. An electrochemical sensor, for example modeled on a two-state lambda sensor, may also be used for the detection of further gases and/or different substances. The mixed-potential sensor may be used in particular as an NH3 or HC sensor.

In the case of the sensor on the basis of thin-film ion conductors, various mixed-potential units for various substances may be combined. For the substances to be investigated, optimized measuring electrodes may be attached on the thin-film ion conductor. In this case, a dedicated measuring electrode may be provided for each substance. Or one measuring electrode may be designed for more than just one substance. One of the substances that can be sensed may be oxygen, one function then being as a lambda sensor. For optimal functioning for the detection of the substance, there is a specific optimal operating temperature Ti. Setting the temperature Ti for the evaluation of the measuring signal at the corresponding measuring electrode allows the concentration of the substance to be measured to be determined. In the case of a sensor on the basis of a thin-film ion conductor, when heating up from temperature T1 to temperature T2 the sensor can, on account of the low thermal capacity, reach the temperature T2 more quickly than a sensor with a higher thermal capacity (thick-film technology). For the same reason, when cooling down from T2 to T1, the sensor can dissipate the temperature more quickly, since the lower thermal capacity means that a lower heat dissipation leads to a strong lowering of the temperature. This quicker reaching of the target temperatures Ti may be combined with a temperature profile or a temperature modulation, in that there is constant changing on a temperature ramp between the temperature levels T1, T2 and optionally further levels. In this case, a correspondingly quick measurement of the concentrations of all the substances can be performed. The properties of the miniaturized sensor make it possible that temperature changes proceed much more quickly, and consequently a quasi-continuous signal can be sensed for the various substances.

The approach presented here allows currents and/or voltage profiles at the signal electrodes and at the heater lines to be influenced.

The exemplary embodiments described and shown in the figures are chosen merely by way of example. Different exemplary embodiments may be combined with one another completely or with respect to individual features. One exemplary embodiment may also be supplemented by features of another exemplary embodiment.

Furthermore, method steps according to the disclosure may be repeated and carried out in a sequence other than that described.

If an exemplary embodiment comprises an “and/or” conjunction between a first feature and a second feature, this should be read as meaning that, according to one embodiment, the exemplary embodiment comprises both the first feature and the second feature and, according to a further embodiment, the exemplary embodiment comprises either only the first feature or only the second feature.

What is claimed is:

1. A method for analyzing a gas, comprising:
measuring an electrical voltage between a reference electrode and a measuring electrode of a gas sensor, the gas sensor having a carrier material for a first thin-film ion conductor and an electrical circuit, the first thin-film ion conductor separating a reference space for a reference gas from a measuring space for the gas, the first thin-film ion conductor including the reference electrode and the measuring electrode with the reference electrode facing the reference space and the measuring electrode facing the measuring space, the reference electrode and the measuring electrode being connected to the electrical circuit; and
determining a partial pressure of a chemical species in the gas, the electrical voltage being processed in the electrical circuit by using a stored processing specification in order to determine the partial pressure.

2. The method according to claim 1, wherein the partial pressure is determined by using a compensation characteristic stored in the electrical circuit to compensate for production tolerances of the gas sensor.

3. The method according to claim 1, wherein the voltage is amplified by a factor stored in the electrical circuit or a mathematical function in order to determine the partial pressure.

4. The method according to claim 1, wherein the gas sensor has a second thin-film ion conductor and the measuring space is formed as a hollow space arranged in the semiconductor substrate, the second thin-film ion conductor separating the measuring space from a gas space for the gas, the measuring space being connected to the gas space by a diffusion barrier, the diffusion barrier being configured to control diffusion of the gas between the measuring space and the gas space, and the second thin-film ion conductor having a first pumping electrode and a second pumping electrode, the first pumping electrode facing the measuring space and the second pumping electrode facing the gas space, and the first pumping electrode and the second pumping electrode being connected to the electrical circuit, the method further comprising:
pumping ions of the chemical species through the second thin-film ion conductor until there is in the measuring space a concentration of the chemical species that is stored in the electrical circuit, an electrical pumping voltage being applied between the first pumping electrode and the second pumping electrode in order to pump the ions through the second thin-film ion conductor; and
sensing an ion current through the second thin-film ion conductor, an electrical current flow between the first pumping electrode and the second pumping electrode being measured in order to sense the ion current, the partial pressure also being determined by using the pumping voltage and the current flow.

5. The method according to claim 4, wherein the pumping voltage is controlled by using the voltage at the first thin-film ion conductor.

6. The method according to claim 4, further comprising determining a temperature of one or more of the first thin-film ion conductor and the second thin-film ion conductor, the partial pressure also being determined by using the temperature.

7. The method according to claim 4, further comprising controlling the temperature of one or more of the first thin-film ion conductor and the second thin-film ion conductor, the temperature of the first thin-film ion conductor being controlled to a first temperature so as to measure the concentration, and/or the temperature of the second thin-film ion conductor being controlled to a second temperature so as to pump the ions.

8. The method according to claim 7, wherein the temperature of the first thin-film ion conductor is controlled to a further temperature so as to measure a further concentration of a further chemical species, and/or the temperature of the second thin-film ion conductor is controlled to another temperature so as to pump the further chemical species, the method further comprising determining a further partial pressure of the further chemical species.

9. The method according to claim 8, wherein one or more of (i) the first temperature and the further temperature are changed at a predetermined time interval and (ii) the second temperature and the other temperature are changed in a predetermined rhythm.

10. A computer program product with program code for carrying out a method for analyzing a gas when the program product is run on a device, the method including:
measuring an electrical voltage between a reference electrode and a measuring electrode of a gas sensor, the gas sensor having a carrier material for a first thin-film ion conductor and an electrical circuit, the first thin-film ion conductor separating a reference space for a reference gas from a measuring space for the gas, the first thin-film ion conductor including the reference electrode and the measuring electrode with the reference electrode facing the reference space and the measuring electrode facing the measuring space, the reference electrode and the measuring electrode being connected to the electrical circuit; and
determining a partial pressure of a chemical species in the gas, the electrical voltage being processed in the electrical circuit by using a stored processing specification in order to determine the partial pressure.
